(19) United States
(12) Patent Application Publication
(10) Pub. No.: US 2010/0050770 A1
(43) Pub. Date: Mar. 4, 2010

(54) APPARATUS AND METHOD FOR MEASURING THE ACCELERATION IMPARTED ON METERED DOSE DELIVERY CONTAINERS

(75) Inventors: Lee A. Barger, Durham, NC (US); Donald D. Munn, Durham, NC (US)

Correspondence Address: GLAXOSMITHKLINE;CORPORATE INTELLECTUAL PROPERTY, MAI B482, FIVE MOORE DR., PO BOX 13398, RESEARCH TRIANGLE PARK, NC, 27709-3398, US

(73) Assignee: SMITHKLINE BEECHAM CORPORATION, Philadelphia, PA (US)

(21) Appl. No.: 11/721,055

(22) PCT Filed: Jan. 6, 2006
(86) PCT No.: PCT/US2006/000446

§ 371 Date: Nov. 20, 2009

Related U.S. Application Data
(60) Provisional application No. 60/642,584, filed on Jan. 10, 2005.

(51) Int. Cl. G01P 15/00

(52) U.S. Cl. 73/514.01

(57) ABSTRACT

An apparatus comprises a main body member; and a transducer in communication with the main body member, the transducer adapted to receive an acceleration force imparted to the main body member. A method for assessing acceleration forces imparted to an apparatus comprises a main body member and transducer in communication with the main body member, the transducer adapted to receive the external acceleration force imparted to the main body member, wherein the transducer converts the acceleration forces to electrical signals and the acceleration forces are accessed.

### FIELD OF THE INVENTION

The present invention is generally directed to the manufacturing of sealed containers equipped with valves, such as those employed in metered dose delivery units.

### BACKGROUND OF THE INVENTION

Metered Dose Inhalers or MDIs are employed as a means of delivering medicaments to patients in need thereof via aerosol administration. More specifically, pharmaceutical formulations are delivered to the patient which contain one or more medicaments and a propellant.

A typical MDI includes, among other components, a can or canister that houses the formulation therein. A significant factor is ensuring that the formulation is sufficiently mixed during patient use to allow for as uniform and consistent dosing as possible. During can testing, it is therefore important to understand as best as possible the level of mixing the formulation in the can is experiencing. Data collection is made in an attempt to quantify the actual motion or acceleration of the can. It is highly desirable that any tests or QC measurements be done under consistent conditions, including the Initial and subsequent shaking steps of the can. Many of the products have the potential to be very sensitive to even small changes in shaking. Being able to quantify the similarity of shakes from one test/test batch to the next helps reduce (through training) or quantify (through recording) the Inherent error of experimental setup and operator induced variation.

One method of carrying out acceleration measurements on the can is to place a wired accelerometer in a similar sized can, then run the wire to an electronic apparatus to record the results. Notwithstanding any advantages of this technique, such a method has a perceived shortcoming in that it is difficult, if not impossible to run the device through a machine as a normal can, due to the wire. Thus, the machine must be stopped, device inserted, then restart the machine. This may lead to inaccurate measurements since machine is not running in continuous, steady state mode. Additionally, the wire has the capability of preventing or substantially impeding the ability of people to shake the device as they would a normal can, either chaining the shake to work around the cable, or the cable actually slowing down the shake. Also, the wired version is subject to possible damage.

There is a need in the art to address the problems noted above.

### SUMMARY OF THE INVENTION

In one aspect, the invention comprises an apparatus comprising a main body member; and a transducer in communication with the main body member, the transducer adapted to receive an acceleration force imparted to the main body member.

In another aspect, the invention provides a method for assessing acceleration forces imparted to an apparatus. The method comprises applying an external acceleration force to an apparatus, the apparatus comprising a main body member and a transducer in communication with the main body member, the transducer adapted to receive the external acceleration force imparted to the main body member, wherein the transducer converts the acceleration forces to electrical signals and the acceleration forces are accessed.

These and other aspects are provided by the invention.

### BRIEF DESCRIPTION OF THE DRAWINGS

FIG. 1A is a side elevation view of a canister to be measured by a measuring apparatus provided in accordance with the present invention, with a valve assembly having been installed onto the canister;

FIG. 1B is a top plan view of the canister illustrated in FIG. 1A;

FIG. 1C is a partially cutaway view of the valve assembly illustrated in FIG. 1A;

FIG. 2 is a partially cutaway view of a metered dose inhaler unit consisting of an actuator operating in conjunction with the valve-equipped canister illustrated in FIG. 1A;

FIG. 3 is a perspective exploded view of an apparatus employed in accordance with the present invention;

FIG. 4 is a perspective view of an apparatus employed in accordance with the present invention;

FIG. 5 illustrates a circuit card employed in accordance with the invention;

FIG. 6a is a perspective exploded view of a battery charger for use in accordance with the present invention;

FIG. 6b is a diagram illustrating the battery charger set forth in FIG. 6a as assembled;

FIG. 7 is a diagram illustrating an assembly in communication with an external computer device in accordance with the present invention;

FIG. 8 is a side view illustrating the application of an acceleration force to an apparatus in accordance with the invention.

### DETAILED DESCRIPTION OF THE INVENTION

The invention will now be described with respect to the embodiments set forth herein. It should be appreciated that these embodiments are set forth to illustrate the invention, and that the invention is not limited to these embodiments. Such embodiments may or may not be practiced mutually exclusive of each other.

All publications, patents, and patent applications cited herein, whether supra or Infra, are hereby incorporated herein by reference in their entirety to the same extent as if each individual publication, patent, or patent application was specifically and individually indicated to be incorporated by reference.

It must be noted that, as used in the specification and appended claims, the singular forms “a”, “an” “the” and “one” include plural referents unless the content clearly dictates otherwise.

Medicaments that may be employed in MDIs set forth herein include a variety of pharmaceutically active ingredients, such as, for example, those which are useful in inhalation therapy. In general, the term “medicament” is to be broadly construed and include, without limitation, actives, drugs and bioactive agents, as well as biopharmaceuticals. In various embodiments, medicament may be present in micronized form. Appropriate medicaments may thus be selected from, for example, analgesics, (e.g., codeine, dihydromorphine, ergotamine, fentanyl or morphine); anginal preparations, (e.g., diltiazem; antiallergics, e.g., cromoglicate, ketotifen or nedocromil); antiinfectives (e.g., cephalosporins, penicillins, streptomycin, sulphonamides, tetracyclines and pentamidine); antihistamines, (e.g., methapyrilene); anti-inflammatories, (e.g., beclometasone dipropionate, fluticasone propionate, flunisolide, budesonide, rofleponide, mometasone furoate, ciclesonide, triamcinolone acetonide or 6α, 9α-difluoro-11β-hydroxy-16α-methyl-3-oxo-17α-propionyloxy-androsta-1,4-diene-17β-carbothioic acid S-(2-oxo-tetrahydro-furan-3-yl) ester)); antitussives, (e.g., noscapine; bronchodilators, e.g., albuterol (e.g. as sulphate), salmeterol (e.g. as xinafoate), ephedrine, adrenaline, fenoterol (e.g as hydrobromide), formoterol (e.g., as fumarate), isoprenaline, metaproterenol, phenylephrine, phenylpropanolamine, pirbuterol (e.g., as acetate), reproterol (e.g., as hydrochloride), rimiterol, terbutaline (e.g., as sulphate), isoetharine, tulobuterol, 4-hydroxy-7-[2-[[2-[[3-(2-(henylethoxy)propyl]sulfonyl]ethyl]-amino]ethyl-2(3H)-benzothiazolone), 3-(4-{[6-({(2R)-2-hydroxy-2-[4-hydroxy-3-(hydroxymethyl)phenyl]ethyl}amino) hexyl]oxy}butyl) benzenesulfonamide, 3-(3-{[7-({(2R)-2-hydroxy-2-[4-hydroxy-3-(hydroxymethyl)phenyl]ethyl}amino)heptyl]oxy}propyl)benzenesulfonamide, 4-{(1R)-2-[(6-{2-[(2,6-dichlorobenzyl)oxy]ethoxy}hexyl)amino]-1-hydroxyethyl}-2-(hydroxymethyl)phenol; diuretics, (e.g., amiloride; anticholinergics, e.g., ipratropium (e.g., as bromide), tiotropium, atropine or oxitropium); hormones, (e.g., cortisone, hydrocortisone or prednisolone); xanthines, (e.g., aminophylline, choline theophyllinate, lysine theophyllinate or theophylline); therapeutic proteins and peptides, (e.g., insulin). It will be clear to a person skilled in the art that, where appropriate, the medicaments may be used in the form of salts, (e.g., as alkali metal or amine salts or as acid addition salts) or as esters (e.g., lower alkyl esters) or as solvates (e.g., hydrates) to optimise the activity and/or stability of the medicament. It will be further clear to a person skilled in the art that where appropriate, the medicaments may be used in the form of a pure isomer, for example, R-salbutamol or RR-formoterol.

Particular medicaments for administration using pharmaceutical formulations in accordance with the invention include anti-allergics, bronchodilators, beta agonists (e.g., long-acting beta agonists), and anti-inflammatory steroids of use in the treatment of respiratory conditions as defined herein by inhalation therapy, for example cromoglicate (e.g. as the sodium salt), salbutamol (e.g. as the free base or the sulphate salt), salmeterol (e.g. as the xinafoate salt), bitolterol, formoterol (e.g. as the fumarate salt), terbutaline (e.g. as the sulphate salt), reproterol (e.g. as the hydrochloride salt), a beclometasone ester (e.g. the dipropionate), a fluticasone ester (e.g. the propionate), a mometasone ester (e.g., the furoate), budesonide, dexamethasone, flunisolide, triamcinolone, tripredane, (22R)-6α,9α-difluoro-11β,21-dihydroxy-16α, 17α-propylmethylenedioxy-4-pregnen-3,20-dione. Exemplary long-acting beta agonists include, without limitation, salmeterol (e.g. as xinafoate), 3-(4-{[6-({(2R)-2-hydroxy-2-[4-hydroxy-3-(hydroxymethyl)phenyl]ethyl}amino)hexyl]oxy}butyl) benzenesulfonamide, 3-(3-{[7-({(2R)-2-hydroxy-2-[4-hydroxy-3-(hydroxymethyl) phenyl]ethyl}amino)heptyl]oxy}propyl) benzenesulfonamide, 4-{(1R)-2-[(6-{2-[(2,6-dichlorobenzyl)oxy]ethoxy}hexyl)amino]-1-hydroxyethyl}-2-(hydroxymethyl)phenol, 2-hydroxy-5-((1R)-1-hydroxy-2-{[2-(4-{[(2R)-2-hydroxy-2-phenylethyl]amino}phenyl)ethyl]amino}ethyl)phenylformamide, and 8-hydroxy-5-{(1R)-1-hydroxy-2-[(2-{4-[(6-methoxy-1,1′-biphenyl-3-yl)amino]phenyl}ethyl)amino]ethyl}quinolin-2(1H)-one. Exemplary anti-inflammatory steroids include, without limitation, fluticasone propionate, (6α,11β,16α,17α)-6,9-difluoro-17-{[(fluoromethyl)thio]carbonyl}-11-hydroxy-16-methyl-3-oxoandrosta-1,4-dien-17-yl 2-furoate, and (6α,11β,16α,17α)-6,9-difluoro-17-{[(fluoromethyl)thio]carbonyl}-11-hydroxy-16-methyl-3-oxoandrosta-1,4-dien-17-yl 4-methyl-1,3-thiazole-5-carboxylate.

Medicaments useful in erectile dysfunction treatment (e.g., PDE-V Inhibitors such as vardenafil hydrochloride, along with alprostadil and sildenafil citrate) may also be employed. It should be understood that the medicaments that may be used in conjunction with the inhaler are not limited to those described herein.

Salmeterol, especially salmeterol xinafoate, salbutamol, fluticasone propionate, beclomethasone dipropionate and physiologically acceptable salts and solvates thereof are especially preferred.

It will be appreciated by those skilled in the art that the formulations according to the invention may, if desired, contain a combination of two or more medicaments. Formulations containing two active ingredients are known for the treatment of respiratory disorders such as asthma, for example, formoterol (e.g. as the fumarate) and budesonide, salmeterol (e.g. as the xinafoate salt) and fluticasone (e.g. as the propionate ester), salbutamol (e.g. as free base or sulphate salt) and beclometasone (as the dipropionate ester) are preferred.

In one embodiment, a particular combination that may be employed is a combination of a beta agonist (e.g., a long-acting beta agonist) and an anti-inflammatory steroid. One embodiment encompasses a combination of fluticasone propionate and salmeterol, or a salt thereof (particularly the xinafoate salt). The ratio of salmeterol to fluticasone propionate in the formulations according to the present invention is preferably within the range 4:1 to 1:20. The two drugs may be administered in various manners, simultaneously, sequentially, or separately, in the same or different ratios. In various embodiments, each metered dose or actuation of the inhaler will typically contain from 25 μg to 100 μg of salmeterol and from 25 μg to 500 μg of fluticasone propionate. The pharmaceutical formulation may be administered as a formulation according to various occurrences per day. In one embodiment, the pharmaceutical formulation is administered twice daily.

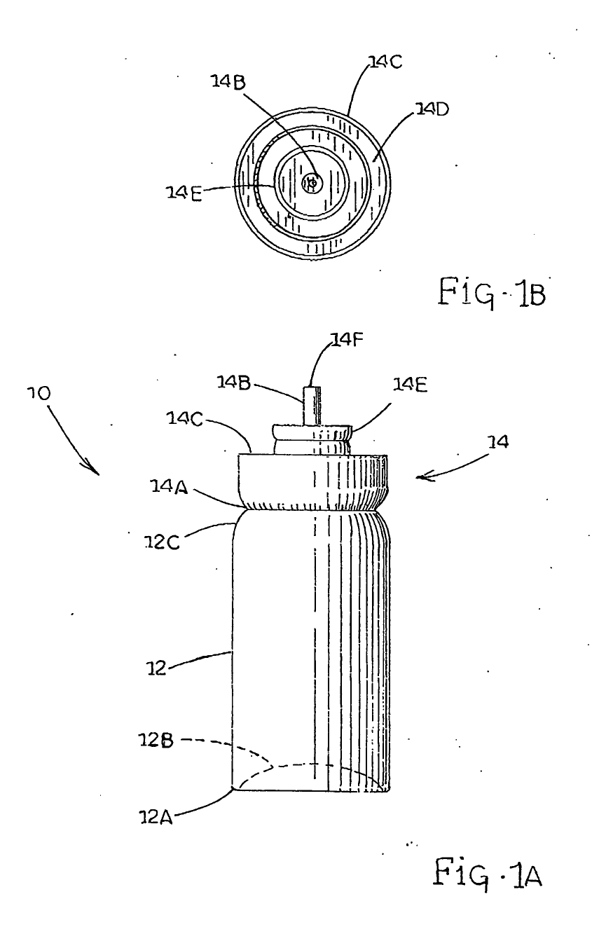

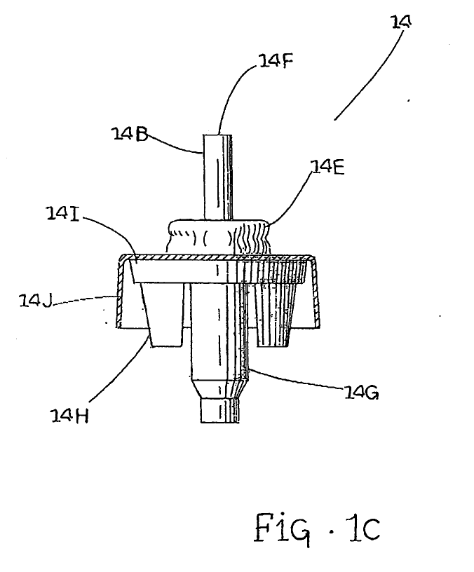

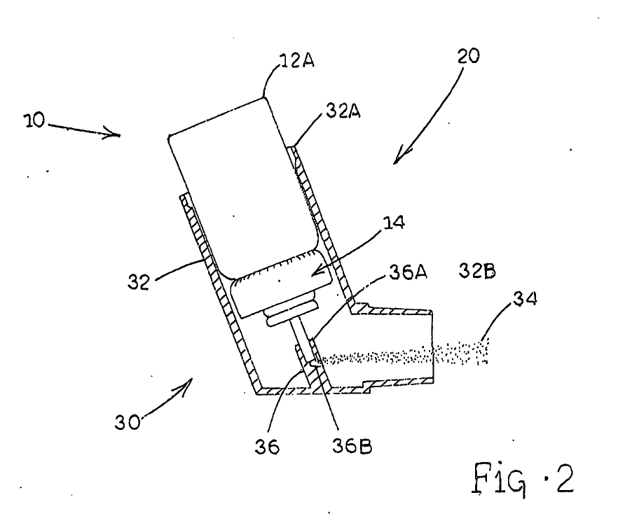

Referring now to FIGS. 1A-1C, a typical MDI canister, generally designated 10, is illustrated. Canister 10 includes a canister body 12 having a typical diameter of 0.87 inches. There are typically three standard sizes for canister 10, which may be referred to as short, medium, and tall. Short, medium and tall canisters 10 typically have respective heights of 1.54, 1.93, and 2.37 inches. Short canister 10 typically delivers 60 or 80 metered doses, medium canister 10 typically delivers 120 doses, and tall canister 10 typically delivers 200 doses.

As shown in FIG. 1A, canister body 12 is bounded by a closed bottom canister end 12A, which usually has a concave profile 12B (shown in phantom), and an open upper canister end concealed by a valve assembly or cap, generally designated 14. A canister shoulder 12C provides a regional transition from canister body 12 to the upper canister end. Valve cap 14 is sealed over the upper canister end at a crimped section 14A. A hollow valve stem 14B extends outwardly from valve assembly 14. Valve assembly 14 contains a valve (not shown) communicating with the interior of canister body 12 in operative association with valve stem 14B. As shown in FIG. 1B, a top surface 14C of valve assembly 14 is flat in at least an annular region 14D of valve assembly 14. A raised top portion 14E of valve assembly 14 houses one or more gaskets (not shown) for sealing valve stem 14B as well as a metering chamber. The internally disposed end (not shown) of valve stem 14B fluidly communicates with the valve. The opposing, externally disposed end 14F of valve stem 14B serves as the dose delivery outlet. When valve stem 14B is depressed downwardly against the bias of its return spring, it momentarily opens the valve and thereby delivers a controlled, metered, atomized dose of medicament through valve stem 14B. The internal design and interaction of valve stem 14B, its return spring and the valve ensure that the valve is closed after the metered quantity of medicament is emitted through valve stem 14B, and also that the metered quantity is substantially consistent with repeated actuations of valve assembly 14.

Referring to the partially cutaway view of valve assembly 14 in FIG. 1C, the valve, the return spring and a portion of valve stem 14B are contained within an internal housing or valve body 14G of valve assembly 14. A resilient slotted ring 14H and a gasket 141 are also provided to ensure a good seal when valve assembly 14 is installed onto open-ended canister body 12. Additionally, valve assembly 14 includes a metallic outer skirt or ferrule 14J for use as the crimping material.

Referring to FIG. 2, a typical MDI unit, generally designated 20, is illustrated. Canister 10 with valve assembly 14 installed thereon has been loaded into an MDI actuator, generally designated 30. Actuator 30 includes a housing 32 having one open end 32A into which canister 10 has been loaded, and another open end 32B serving as the mouthpiece through which atomized medicament 34 is emitted from MDI unit 20. A nozzle element 36 is formed in housing 32. Nozzle element 36 includes a valve stem-receiving bore 36A fluidly communicating with a nozzle orifice 36B aimed toward the opening of mouthpiece 32B. MDI unit 20 is actuated by pressing down on exposed canister end 12A.

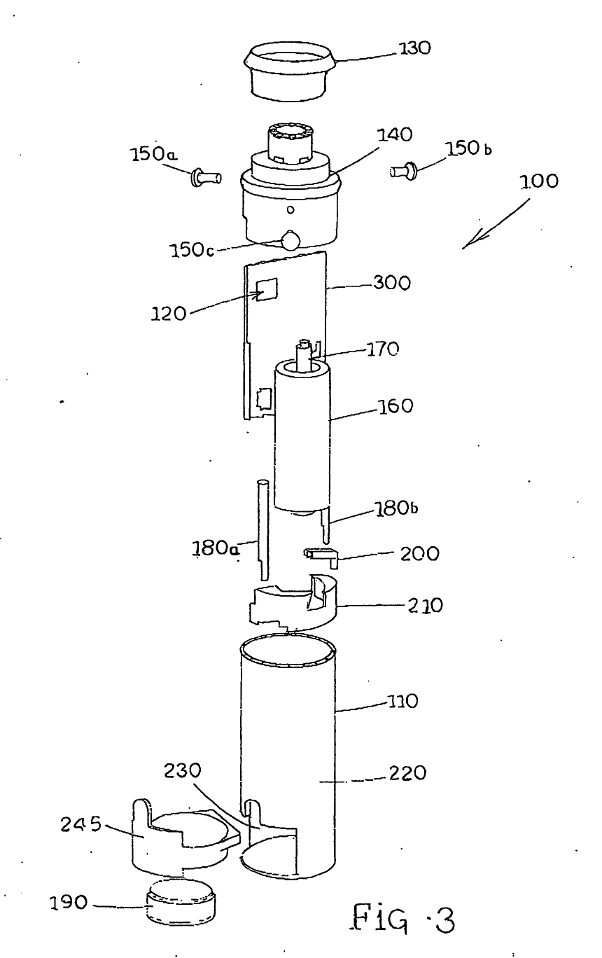

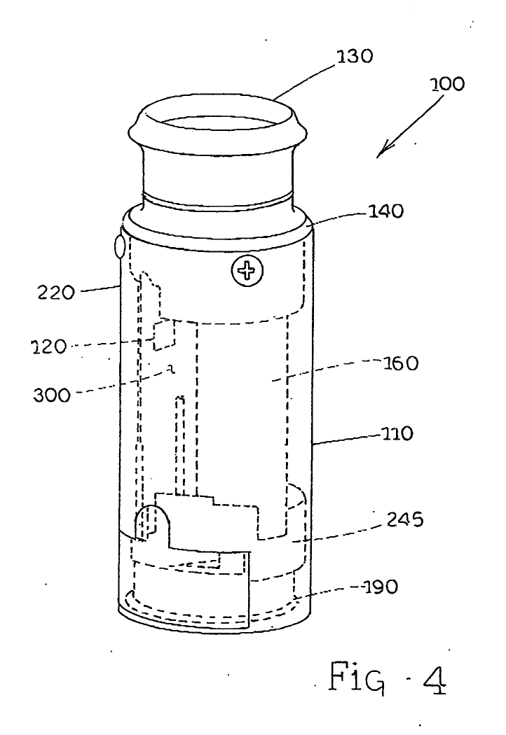

FIGS. 3 and 4 illustrate apparatus 100 in accordance with the present invention. Apparatus 100 is configured to simulate a canister 10 without the presence of valve assembly 14. As shown, the apparatus 100 includes main body member 110 and transducer or accelerometer 120 in communication with the main body member 110. The transducer or accelerometer 120 is in communication with main body member 110 in that external motion applied to the main body member 110 is also experienced by the transducer or accelerometer 120. In accordance with the invention, the transducer 120 is adapted to receive an acceleration force imparted to main body member 110. As described in more detail herein, transducer 120 is present on a circuit card. The apparatus 100 is one that may be used as a canister in an MDI production line.

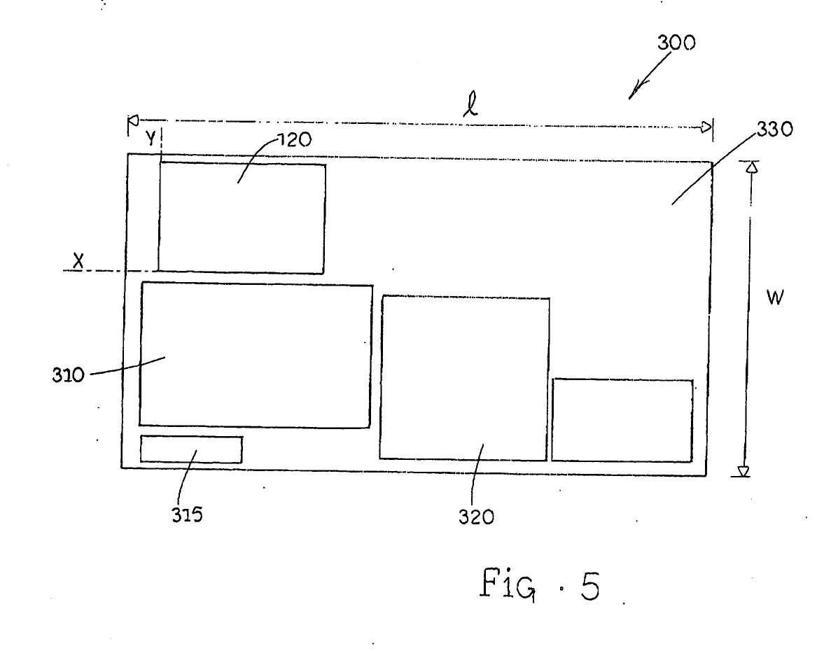

One embodiment of transducer 120 is illustrated in FIG. 5. In this embodiment, transducer 120 is defined by an x-axis (denoted by x) and a y-axis (denoted by y). As shown, transducer 120 is present on a circuit card 300 containing the transducer 120. One embodiment of an accelerometer device is an analog devices ADXL202, but others may also be employed. An indicator LED 315, as well as other electronics can also be used.

An embodiment of the circuit card 300 employed in accordance with the invention will now be described in detail in FIG. 5. In particular, the circuit card 300 includes, without limitation, three basic sections, the power section 310, the processor 320 and the transducer 120. The circuit card 300 also has a length l and a width w which may be of various dimensions. In one embodiment, for example, l is 1.30 inches and w is 0.72 inches.

In one embodiment, the power section 310 is built up from a 1.2 volt rechargeable battery 160, a DC-DC step-up converter and the associated discrete components for control and filtering, the selection of which is known in the art. In addition, the circuit is kept at one end of the board on one side of the board to minimize electrical noise and EMI and attempt to keep the sensitive signal integrity. The DC-DC converter was tuned to supply 5 VDC with minimal switching noise transmitted to the 5 volt bus on the circuit card 300. Other components may be employed to form the power section without deviating from the scope of the invention.

In one embodiment, the processor section (e.g., microprocessor) 320 is positioned in the vicinity of the center of the circuit card between the power section and transducer. In such an embodiment, the processor also has a separate “clean” supply that employs a discrete inductor and capacitor to filter out the high frequency switching noise of the power supply.

In one embodiment, the transducer section includes the Analog Devices 2-Axis accelerometer and a number of discrete resistors and capacitors that are used to adjust the timing, output and sensitivity of the transducer. In addition, in one embodiment, the circuit card has a separate ground layer under the transducer that helps to isolate any power supply noise from the supply so the transducer can supply the microprocessor with a clean signal.

The system architecture, component layout and circuit card configuration all work together to provide a compact power system that can supply adequate power while minimizing compromising signal integrity from the acceleration transducer.

Additional components of the apparatus 100 are illustrated in FIGS. 3 and 4. Head member 130 is attached to the main body member 110, and includes a flanged portion extending radially outwardly from a longitudinal axis of the apparatus. The flanged portion includes an aperture coaxially disposed about the longitudinal axis. Head member 130 is positioned on can top 140 which serves to secure all other components inside the shell with the assistance of three screws 150a, 150b and 150c. Advantageously, head member 130 is removable allowing various valve assemblies to be clamped thereto. A power source 160 (e.g., battery) is positioned within the apparatus 100, and is preferably rechargeable. In this embodiment, the battery attaches to circuit card 300 by soldered contact pads on both positive and negative terminals. Spring 170 above battery 160 makes contact between the battery's ground and the metal frame of apparatus 100. Spring contact pads 180a and 180b are present as two cylinders positioned on opposing sides of battery 160. Pad 180a contacts data module 190 for transfer of recorded information from circuit card 300. Pad 180b serves as both spring and electrical contact for the power switch 200. A cylindrical component known as a spacer 210 is positioned to secure and align the bottom portion of the electronics. Cylindrical shell 220 is configured to contain many of the components described herein, and has an opening 230 at its bottom to receive a data module 190 (shown) or a charging device (not shown). Additionally, data tray 245 may be employed for Insertion into an opening into the cylindrical shell as shown, and is on top of data module 190. Data tray 245 may be constructed by techniques known to one skilled in the art. Data tray 245 may be in communication with data module 190 as well as optionally other electronic components present in apparatus 100. Data tray 245 may be configured to perform a variety of operations: (1) extract information from data module 190, (2) serve in a sealing capacity with respect to cylindrical shell 220, and/or (3) activate or deactivate the power employed with respect to battery 160.

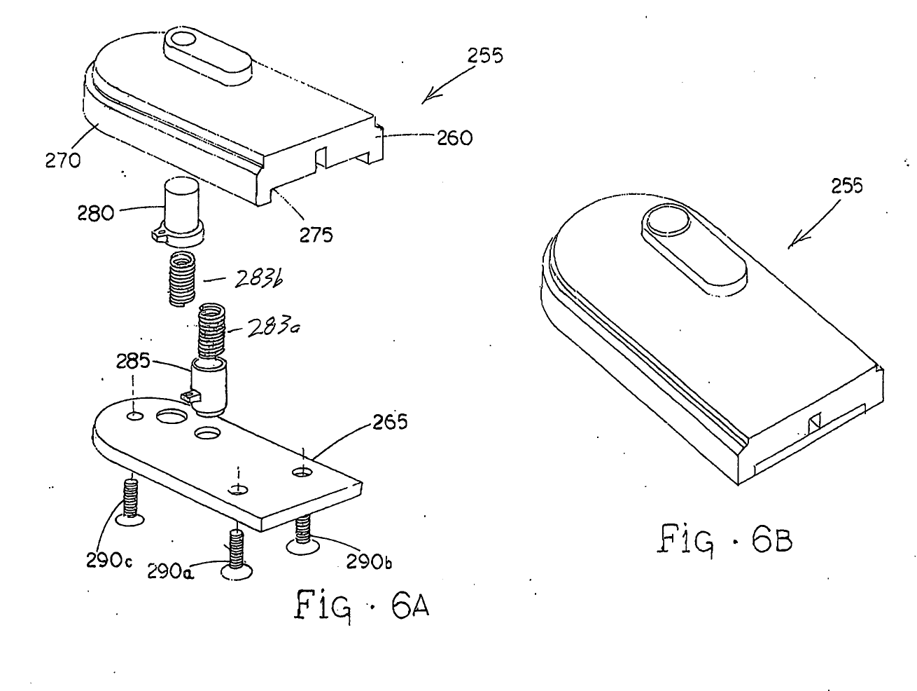

Optionally, battery 160 may be rechargeable. As an example, in one embodiment, upon removal of data module 190, a charger may be inserted into opening 230 which functions to recharge battery 160. One example of a charger is set forth in FIGS. 6a and 6b, denoted as 255. As set forth in FIG. 6a, charger 255 includes a top plate 260 and a bottom plate 265. Top plate 260 has a peripheral wall 270 surrounding the plate so as to form opening 275 which is fitted to receive bottom plate 265. Spring loaded contacts 280 and 285 are configured to be received in top and bottom plates 260 and 265 respectively. Springs 283a and 283b are present and used in conjunction with contacts 280 and 285; however, it should be appreciated that contacts may be employed without the use of springs without departure from the scope of the invention. Fasteners 290a, 290b, and 290c are also present and assists in maintaining the top and bottom plates in contact. In operation, charger 255 contacts with the positive terminal of battery 160 (not shown). Charger 255 also grounds against the bottom of housing 220. An embodiment of an assembled charger 255 is illustrated in FIG. 6b. One example of the charger can be found in “Apparatus and Method for Measuring Forces Imparted on Valve Assemblies of Metered Dose Delivery Containers During Manufacture Thereof” Ser. No. 10/480,729 filed Dec. 12, 2003, the disclosure of which is incorporated herein by reference in its entirety.

In general, the apparatus includes electronic circuitry, including, as an example those components known in the art, which communicates with the transducer 120 and is adapted to receive an electrical output signal produced by the transducer 120. The electrical signal is indicative of a magnitude of the acceleration force imparted to the main body member. In one embodiment, the electronic circuitry may be disposed within a housing of the apparatus. Alternatively, in another embodiment, the electronic circuitry may be disposed remotely in relation to a housing of the apparatus. In such an embodiment, as an example, the circuitry can communicate with the transducer via wireless communication (e.g., BlueTooth or IR Communication links). Alternatively, the circuitry can communicate with the transducer through an electrical conduit.

As disclosed above, the electrical circuitry may be disposed within a housing of the apparatus. In one embodiment, as an example, the electronic circuitry is present in a data module 190 which is capable of processing the output signal produced by the transducer 120. In the embodiment illustrated in FIG. 3, data module 190 is removable from the apparatus. Data module 190 may be configured in a manner known in the art so as to be capable of processing the output signal produced by the transducer. As an example, data module 190 may contain various types of memory and/or processing components (e.g., S-RAM).

More specifically, in one embodiment and as an example, the insertion of data module 190 in opening in cylindrical shell 220 and its contact with a support plate serves to power ON battery 160, thus allowing data module 190 to communicate with transducer 120 via circuit card 300. Upon completion of the acceleration data gathering session, data module 190 may be removed from a support plate which serves to turn the battery 160 OFF. As desired by the end user, data module 190 may then be placed in communication with an additional electronic device(s) (not shown) for any number of operations such as, for example, data processing, storage, and/or display. As an example, data module 190 may be inserted in a computer.

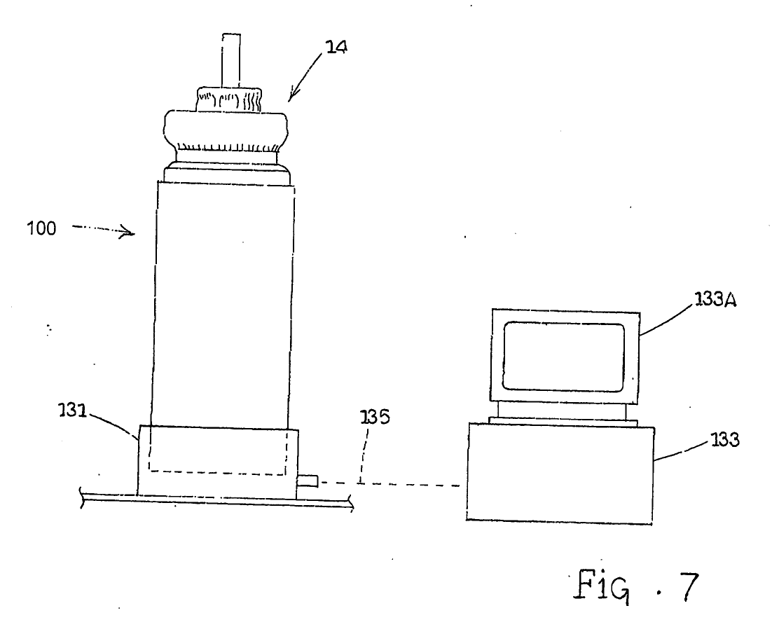

In accordance with the present invention, the apparatus may include at least one electrical contact accessible from outside the housing. The electrical contact may be employed in a manner known in the art. The electrical contact may be adapted to enable communication between the electronic circuitry and an external computer device disposed remotely in relation to the housing. This embodiment is generally depicted in FIG. 7.

In a particular embodiment, the apparatus may further include a mode switch electrically communicating with the electronic circuitry and accessible from outside of the housing. Advantageously, the mode switch is alternatively switchable to a record mode of the apparatus, wherein electrical communication is established between the transducer and the electronic circuitry in the record mode, and electrical communication is established between the electronic circuitry and the external computer device in the communicate mode.

In one embodiment, the mode switch may be mounted to the apparatus. The mode switch may be mounted in various manners, the selection of which is known to one skilled in the art. For example, in one embodiment, the mode switch may be adapted so as to be mounted in a cradle, wherein the cradle includes the mode switch. The cradle may include a contact adapted for electrical communication with the apparatus to provide power to the apparatus in a manner known to one skilled in the art.

As one possible embodiment of the mode switch, a RECORD/COMMUNICATE switch could be mounted in the base of the cradle. In this configuration, the mounting of the apparatus of the invention into the cradle may be capable of automatically switching the apparatus to the COMMUNICATE mode, and the removal of the apparatus from the cradle can automatically switch the apparatus to the RECORD mode. As a further alternative, a suitable electrical contact element can be added to the cradle to supply low voltage power to the apparatus while the apparatus is communicating through the cradle, thereby conserving battery life. The modifications required to implement these alternative embodiments should be understood by persons skilled in the art. Such modifications may include the addition of one or more contact pads to the base of the apparatus.

In one embodiment, referring to FIG. 7, acceleration force measuring device 100 is preferably adapted to be mounting in a cradle 131 such that contact pads may communicate with complementary contacts of cradle 131. Cradle 131 communicates with a data processing device 133 such as a computer through an electrical conduit 135. Thus, in COMMUNICATE mode, communication is established between a data logger than may be contained within device 80 and externally disposed computer 133 to enable transfer of data from device 80 to computer 133 for further data storage, interpretation and processing. Moreover, a display portion 133A of computer 133 can be used to display a human-readable indication of the acceleration forces measured by transducer 120 as a result of forces being applied thereto (as described in greater detail herein).

In another aspect, the invention encompasses a method for accessing acceleration forces imparted to an apparatus. The method includes applying an external acceleration force to an apparatus. The apparatus includes a main body member and a transducer in communication with the main body member. The transducer is adapted to receive the external acceleration force imparted to the main body member. The transducer converts the acceleration forces to electrical signals and the acceleration forces are accessed. Such forces may be accessed by employing electrical data gathering and processing devices and techniques including, without limitation, those described herein.

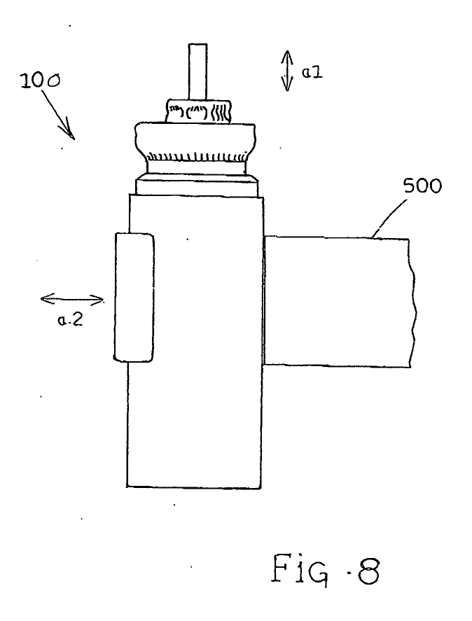

The step of applying an external force to an apparatus may be carried out by various manners, as illustrated in FIG. 8. For example, in one embodiment, the external force (denoted as 500) may be applied by a human. In another embodiment, as an example, the external force may be applied by a device. In this embodiment, the external force may be applied in an up and down motion (denoted by a₁) and/or in a linear motion (denoted by a₂). Rotational acceleration may be determined from components a₁ and a₂ and some a priori knowledge of the experimental setup. Linear acceleration may be directly measured. Variations from these motions are encompassed by the present invention.

It will be understood that various details of the invention may be changed without departing from the scope of the invention. Furthermore, the foregoing description is for the purpose of illustration only, and not for the purpose of limitation—the invention being defined by the claims.

What is claimed is:

1. An apparatus comprising:
(a) a main body member; and
(b) a transducer in communication with the main body member, the transducer adapted to receive an acceleration force imparted to the main body member.

2. The apparatus according to claim 1, wherein the transducer is rectangular in shape defined by an x-axis and a y-axis, and wherein the acceleration force is selected from the group consisting of a force in the direction of the x-axis, a force in the direction of the y-axis, and combinations thereof.

3. The apparatus according to claim 1, further comprising a head member attached to the main body member.

4. The apparatus according to claim 3, wherein the head member includes a flanged portion extending radially outwardly from a longitudinal axis of the apparatus, the flanged portion includes an aperture coaxially disposed about the longitudinal axis.

5. The apparatus according to claim 1, comprising electronic circuitry communicating with the transducer and adapted to receive an electrical output signal produced by the transducer, the output signal being indicative of a magnitude of the acceleration force imparted to the main body member.

6. The apparatus according to claim 5, wherein the electronic circuitry is disposed remotely in relation to a housing of the apparatus and communicates with the transducer via wireless communication.

7. The apparatus according to claim 5, wherein the electronic circuitry is disposed remotely in relation to a housing of the apparatus and communicates with the transducer through an electrical conduit.

8. The apparatus according to claim 5, wherein the electronic circuitry is disposed within a housing of the apparatus.

9. The apparatus according to claim 8, wherein the electronic circuitry is present in a data module, and wherein said data module is capable of processing the output signal produced by the transducer.

10. The apparatus according to claim 9, wherein the data module is removable from the apparatus.

11. The apparatus according to claim 9, further comprising a battery in communication with said data module.

12. The apparatus according to claim 11, wherein said battery is positioned within said apparatus and is rechargeable.

13. The apparatus according to claim 5, comprising at least one electrical contact accessible from outside the housing and adapted to enable communication between the electronic circuitry and an external computer device disposed remotely in relation to the housing.

14. The apparatus according to claim 13, comprising a mode switch electrically communicating with the electronic circuitry and accessible from outside the housing, the mode switch being alternatively switchable to a record mode of the apparatus and to a communicate mode of the apparatus, wherein electrical communication is established between the transducer and the electronic circuitry in the record mode, and electrical communication is established between the electronic circuitry and the external computer device in the communicate mode.

15. The apparatus according to claim 14 wherein the mode switch is mounted to the apparatus.

16. The apparatus according to claim 14 comprising a cradle in which the apparatus is adapted to be mounted, the cradle including the mode switch.

17. The apparatus according to claim 16 wherein the cradle includes a contact adapted for electrical communication with the apparatus to provide power to the apparatus.

18. A method for assessing acceleration forces imparted to an apparatus, said method comprising:
applying an external acceleration force to an apparatus, the apparatus comprising a main body member and a transducer in communication with the main body member, the transducer adapted to receive the external acceleration force imparted to the main body member, wherein the transducer converts the acceleration forces to electrical signals and the acceleration forces are accessed.

19. The method according to claim 18, wherein said step of applying an external force to an apparatus is carried out by a human.

20. The method according to claim 18, wherein said step of applying an external force to an apparatus is carried out by a device.

21. The method according to claim 18, wherein the transducer is rectangular in shape defined by an x-axis and a y-axis, and wherein the acceleration force is selected from the group consisting of a force in the direction of the x-axis, a force in the direction of the y-axis, and combinations thereof.

22. The method according to claim 18, wherein the apparatus further comprising a head member attached to the main body member.

23. The method according to claim 22, wherein the head member includes a flanged portion extending radially outwardly from a longitudinal axis of the apparatus, the flanged portion includes an aperture coaxially disposed about the longitudinal axis.

24. The method according to claim 18, comprising electronic circuitry communicating with the transducer and adapted to receive an electrical output signal produced by the transducer, the output signal being indicative of a magnitude of the acceleration force imparted to the main body member.

25. The method according to claim 24, wherein the electronic circuitry is disposed remotely in relation to a housing of the apparatus and communicates with the transducer through an electrical conduit.

26. The method according to claim 25, wherein the electronic circuitry is disposed remotely in relation to a housing of the apparatus and communicates with the transducer via wireless communication.

27. The method according to claim 24, wherein the electronic circuitry is disposed within a housing of the apparatus.

28. The method according to claim 27, wherein the electronic circuitry is present in a data module, and wherein said data module is capable of processing the output signal produced by the transducer.

29. The apparatus according to claim 28, further comprising a battery in communication with said data module.

30. The apparatus according to claim 29, wherein said battery is positioned within said apparatus and is rechargeable.

31. The method according to claim 28, wherein the data module is removable from the apparatus.

32. The method according to claim 24, comprising at least one electrical contact accessible from outside the housing and adapted to enable communication between the electronic circuitry and an external computer device disposed remotely in relation to the housing.

33. The method according to claim 32, comprising a mode switch electrically communicating with the electronic circuitry and accessible from outside the housing, the mode switch being alternatively switchable to a record mode of the apparatus and to a communicate mode of the apparatus, wherein electrical communication is established between the transducer and the electronic circuitry in the record mode, and electrical communication is established between the electronic circuitry and the external computer device in the communicate mode.

34. The method according to claim 33, wherein the mode switch is mounted to the apparatus.

35. The method according to claim 33, comprising a cradle in which the apparatus is adapted to be mounted, the cradle including the mode switch.

36. The method according to claim 35 wherein the cradle includes a contact adapted for electrical communication with the apparatus to provide power to the apparatus.
